(19) United States
(12) Patent Application Publication
(10) Pub. No.: US 2012/0151787 A1
(43) Pub. Date: Jun. 21, 2012

(54) MATHEMATICS TOOL

(76) Inventor: Geoff Phillips, Wonga Park (AU)

(21) Appl. No.: 13/152,936

(22) Filed: Jun. 3, 2011

(30) Foreign Application Priority Data
Dec. 17, 2010 (AU) 2010905542

(51) Int. Cl. B43L 7/00

(52) U.S. Cl. 33/484; 33/494

(57) ABSTRACT

The present invention relates to a mathematics tool such as a geometric mathematics template. The tool comprises a body having a 360 degree protractor with angularly spaced graduations and tracing edge extends about the protractor and includes a first tracing edge and a second tracing edge. The first and second tracing edges extend continuously over arcs covering at least 90 degrees and are marked with the angular graduations. In addition, the first and second tracing edges have different radii about a common centre. The mathematics tool enables a user to mark out any angle with ease.

### RELATED APPLICATIONS

This application claims the benefit of priority under 35 U.S.C. Section 119 to Australian Provisional Patent Application Serial No. 2010905542, filed Dec. 17, 2010, which is incorporated herein by reference in its entirety.

This application is related to U.S. DESIGN patent application Ser. No. 29/393,390, entitled “Mathematics Stencil”, filed on Jun. 3, 2011 (Attorney Docket No. 1207.026US1), which claims priority to Australian Patent Application Serial No. 15587/2010, filed Dec. 17, 2010, which is incorporated herein by reference in its entirety.

### FIELD OF THE INVENTION

The present invention relates to a mathematics tool and protractor.

### BACKGROUND

A variety of mathematics tools are available to assist in measuring and marking lines, angles, geometric shapes, and/or mathematical curves. Such tools may also be known as templates or stencils.

A tool that is commonly used in education environments is a clear, planar body with apertures that each have a basic shape, such as a square, circle, triangle, arcs, and the like. The tool also has markings to provide a ruler and a protractor. This type of tool has the advantage of providing a single tool that can be used for several different purposes. One of the disadvantages of such a tool is that the apertures in the planar body provide limitations on the structure of tool, which limits the layout of shapes and markings.

The present invention has been conceived in light of the above disadvantages.

### SUMMARY OF THE INVENTION

The present invention relates to a mathematics tool comprising a body, and the body includes:

a 360 degree protractor having angularly spaced graduations; and

a plurality of tracing edges that each continuously extend over arcs of at least 90 degrees, the tracing edges being marked with angular graduations, and the tracing edges having different radii about a common centre and are arranged circumferentially about the centre so that collectively, the tracing edges encircle a complete 360 degrees of the protractor.

The mathematics tool may comprise only two of the tracing edges.

The two tracing edges may each have arcs of at least 180 degrees that overlap each other at two regions.

The present invention also relates to a mathematics tool comprising a body, and the body comprises:

a 360 degree protractor having a tracing edge extending around the protractor and having angularly spaced graduations, the tracing edge includes a first tracing edge, and a second tracing edge;

the first tracing edge extends continuously over a first arc covering at least 90 degrees and is marked with the angular graduations; and

the second tracing edge extends continuously over a second arc covering at least 90 degrees and is marked with the angular graduations;

wherein the first and second tracing edges have different radii about a common centre.

Although it is possible that body may comprise 3, 4, 5 or more tracing edges, each of at least 90 degrees, the body may comprise only two tracing edges, for example, the first and second tracing edges.

At least one of the first and second tracing edges may extend over at least 180 degrees. Suitably, both of the first and second tracing edges extend over at least 180 degrees.

At least one of the first and second tracing edges may extend over an arc ranging from 180 to 190 degrees. Suitably, both the first and second tracing edges extend over arcs ranging from 180 to 190 degrees.

In one example, the first and second tracing edges may be arranged to cover less than 360 degrees of the protractor. In another example, the first and second tracing edges may be arranged to cover or extend about at least 360 degrees of the protractor.

Although it is possible that the first and second tracing edges may not overlap circumferentially, suitably the first and second tracing edges at least partially overlap circumferentially.

The first and second tracing edges define first and second sectors, respectively, and the sectors are least partially overlap. The first and second sectors may overlap such that one or more portions of the first edge overlaps circumferentially with one or more portions of the second edge.

In certain embodiments, each of the portions of the first edge that overlaps circumferentially with a portion of the second edge defines a sector that is within the range of 0.5° to 5°.

In some embodiments, there are two portions of the first edge that each overlap circumferentially with the second edge.

The sum of angles subtended by the first and second sectors can be greater than 360°. Further, the sum of the angles subtended by the first and second sectors can be approximately 361.5°.

In some alternative embodiments, the sum of the angles subtended by the first and second sectors can be approximately 541.5°.

The first tracing edge may be located on an outer peripheral edge of the body of the protractor or mathematics tool. In another example, the first tracing edge may be provided by a cut out, such as an arcuate aperture or slot, located inwardly of an outer peripheral edge of the body of the protractor or mathematics tool.

The first tracing edge may have a larger radius than the radius of the second tracing edge. In this situation, the second tracing edge may be provided by a cut out, such as an arcuate aperture or arced slot, located inwardly of an outer peripheral edge of the body of the protractor or mathematics tool. The cut out may also be in the form of a semi-circular, major circular segment, or a sector of a circle.

The angularly spaced graduations may be radially directed graduations. In another example, the graduations may be dots or marks that are not radially direction.

The angularly spaced graduations may be oriented to extend in a radial direction and located inwardly of the first tracing edge and intersection therewith.

The angularly spaced graduation may be oriented to extend in a radial direction and located outwardly of the second tracing edge and intersect therewith.

The graduations may comprise a radially inner set of graduations and a radially outer set of graduations. The radially inner set of the graduations may intersect with the second tracing edge and the radially outer set of graduations may intersect with the first tracing edge.

Units of measurement may be located between the radially inner and outer sets of graduations.

The body of the mathematic tool may include a circular protractor portion. The body of the mathematic tool may also include one or more geometric stencils spaced from the protractor region and interconnected thereto by the body. The body of the mathematic tool may also define one or more liner peripheral edges. The inner peripheral edges may include length measurement markings. The length measurement markings may be in imperial and/or metric units.

The angular graduations may be marked in degrees and/or radians.

The origin of the circle may lie within the protractor aperture.

In certain embodiments, the protractor aperture is approximately semi-circular. In other embodiments, the protractor aperture is a major circle segment. In other embodiments, the body of the protractor may be a circle.

The first edge can be one of the outer peripheral edges of the planar body. In some such embodiments, the first edge may intersect tangentially with another of the outer peripheral edges of the planar body.

In some alternative embodiments, the first edge is an edge of a generally arcuate aperture.

In some embodiments, the mathematics tool may further comprise one or more stencil regions within which are located a plurality of template apertures.

The present invention also relates to a mathematics tool comprising a planar body defining outer peripheral edges, the planar body having:

a protractor region with a plurality of angularly spaced radial graduations that are disposed around a circle, a first edge that abuts against a radially outer end of at least some of the radial graduations, and a protractor aperture that includes a second edge that abuts against a radially inner end of at least some of the radial graduations,

wherein the first edge extends circumferentially within a first sector of the circle, and the second edge extends circumferentially within a second sector of the circle, and wherein the first and second sectors overlap such that one or more portions of the first edge overlaps circumferentially with one or more portions of the second edge.

The present invention also relates to a protractor comprising:

a circular body having angularly spaced graduations,

a plurality of tracing edges that each continuously extend over arcs of at least 90 degrees, the tracing edges being marked with angular graduations, and the tracing edges having different radii about a common centre and are arranged circumferentially about the centre so that collectively, the tracing edges encircle a complete 360 degrees of the protractor.

The present invention also relates to a protractor comprising:

a circular body having angularly spaced graduations, a first tracing edge, and a second tracing edge;

the first tracing edge extends continuously over a first arc covering at least 90 degrees and is marked with the angular graduations; and

a second tracing edge extends continuously over a second arc covering at least 90 degrees and is marked with the angular graduations;

wherein the first and second tracing edges have different radii and together, the first and second tracing edges extend about 360 degrees of the protractor.

The first tracing edge may be provided about an outer peripheral edge the circular body, and the first tracing edge completely overlaps the second tracing edge.

The protractor may also include any one or a combination of the features of the mathematical tool described above.

### BRIEF DESCRIPTION OF THE DRAWINGS

In order that the invention may be more easily understood, embodiments will now be described, by way of example only, with reference to the accompanying drawings, in which:

FIG. 1: is a plan view of a mathematics tool in accordance with a first embodiment of the present invention;

FIG. 2: is an enlarged view of the protractor region of the mathematics tool of FIG. 1;

FIG. 3: is an enlarged view of region A in FIG. 2;

FIG. 4: is a plan view of a mathematics tool in accordance with a second embodiment of the present invention;

FIG. 5: is a plan view of a mathematics tool in accordance with a third embodiment of the present invention; and

FIG. 6: is a plan view of a mathematics tool in accordance with a fourth embodiment of the present invention.

### DETAILED DESCRIPTION OF THE DRAWINGS

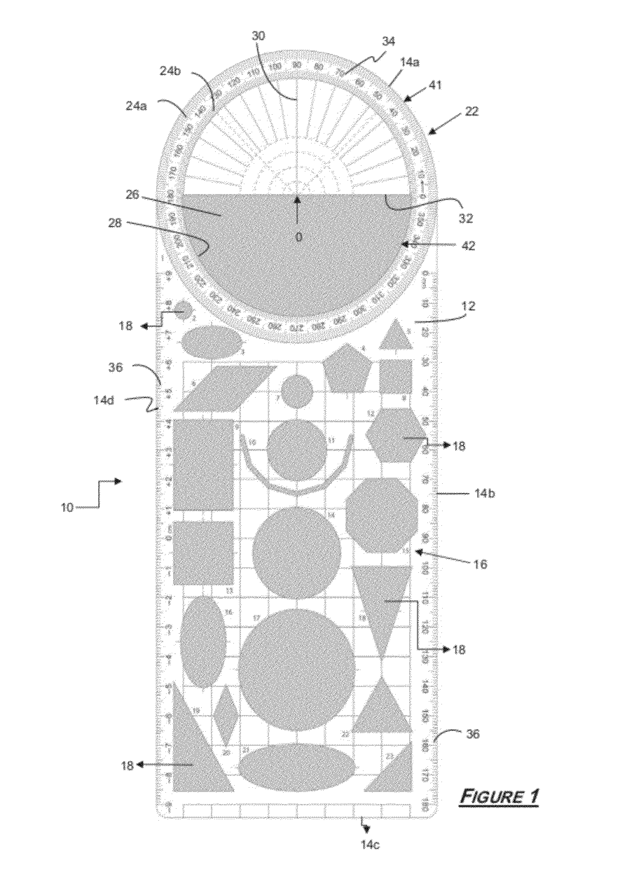

FIGS. 1 to 3 show a mathematics tool 10 according to first embodiment of the present invention. The mathematics tool 10 has a planar body 12 that has outer peripheral edges 14a, 14b, 14c, and 14d of the tool.

The tool 10 has a protractor region 22 within which there are a plurality of angularly spaced radial graduations 24a, 24b that are disposed circumferentially around a first circle 41 that includes a first tracing edge 14a (the first edge 14a) in the shape of an arc. Within the protractor region 22, the first tracing edge 14a of the tool 10 interests or abuts against a radially outer end of the radial graduations, a second tracing edge 28 (the second edge 28) that intersects or abuts against a radially inner end of the radial graduations around a second circle 42, and a protractor aperture 26 that includes the second edge 28. The first edge 14a extends circumferentially within a first sector of the first circle 41, and the second edge 28 extends circumferentially within a second sector of the second circle 42. One or more portions of the first edge 14a overlaps circumferentially, with one or more portions of the second edge 28, as described in further detail below.

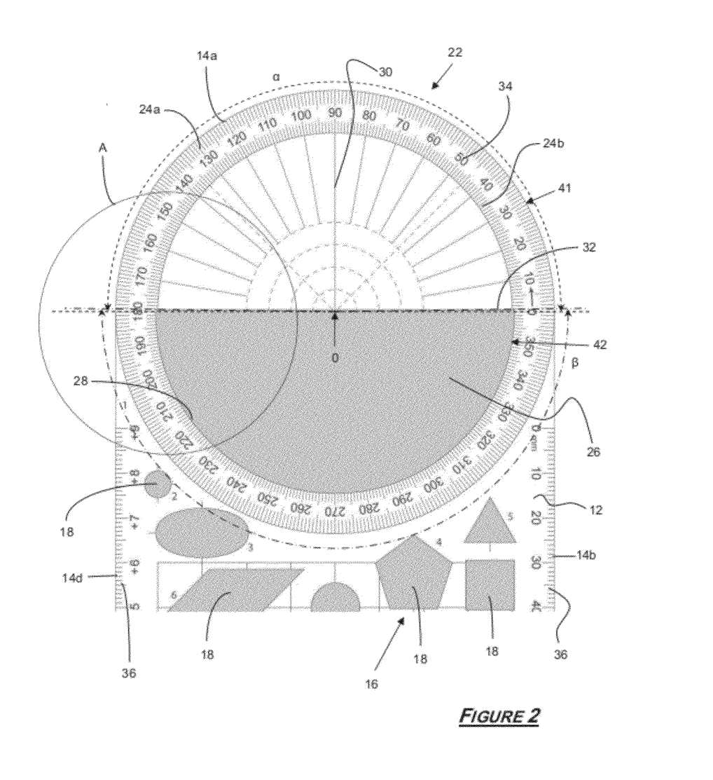

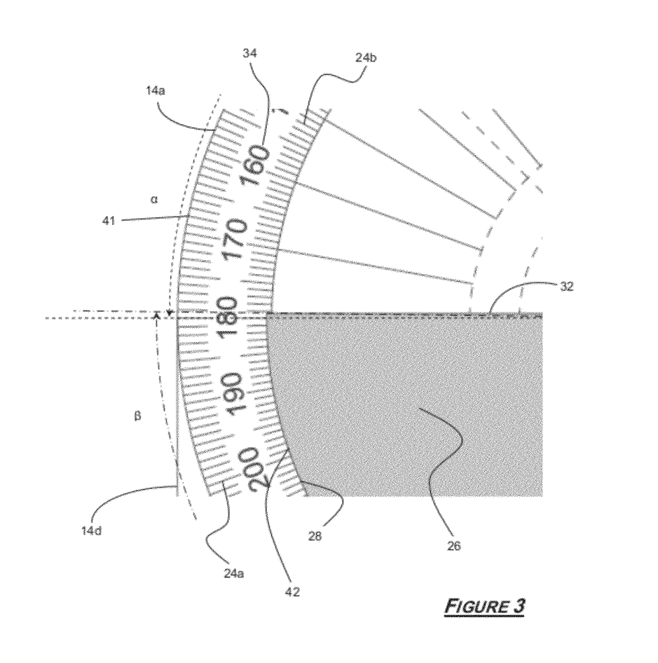

In this particular embodiment, the first edge 14a is also one of the outer peripheral edges 14a of the tool 10. Furthermore, there are two such portions of the first edge 14a that circumferentially overlap with the second edge 28. This is shown in greater detail in FIGS. 2 and 3. It may be noted that the second edge 28 is a circular arc within the protractor region 22.

The mathematics tool 10 has the advantage that any angular marking can be made around the first and second tracing edges 14 a and 28 without interruption. Furthermore, abutment of the first and second edges 14a, 28 against the respective radially outer and inner end of the radial graduations 24a, 24b facilitates measuring and/or marking of angles around the circle with minimal need to count graduations. This has the benefits of minimizing errors in measuring or marking, and shortens the time to complete the task.

In this embodiment, the planar body 12 further has a stencil region 16 within which are located a plurality of template apertures 18. In this particular embodiment, the stencil region 16 has twenty two (22) template apertures 18. In the Figures, a selection of the template apertures 18 has been labelled.

In this particular embodiment, angles within the range of 0° to 180° can be marked along the first edge 14a, and angles within the range of approximately 179° to 361° can be marked along the second edge 28. In other words, both the first and second edges 14a and 28 are at least 90 degrees°.

The sum of angles subtended by the first and second sectors can be greater than 360°. In this particular embodiment, the first sector subtends an angle of 180°, as indicated by the arc-shaped arrow α in FIG. 2. The second sector subtends an angle of approximately 181.5°, as indicated by the arc-shaped arrow β in FIG. 2. Thus, in this particular embodiment, the sum of the angles subtended by the first and second sectors is approximately 361.5°.

Each of the portions of the first edge 14a that overlaps circumferentially with the second edge 28 defines a sector of the circles 41 and 42 that is within the range of 0.5° to 5°. In this particular embodiment, each such sector is approximately 0.75°. Furthermore, each sector corresponds with the overlap of the first and second sectors α, β.

The graduations are in the form of a radially inner set 24b of graduations and a radially outer set 24a of graduations. The mathematics tool displays units of angular measurement 34 located between the radially inner and outer sets of graduations 24a, 24b. The inner and outer sets of graduations 24a, 24b and the units of angular measurement 34 extend circumferentially around concentric circles. In this particular embodiment, the units of angular measurement 34 are in degrees of an arc, at increments of 1/360 of a revolution of the circles 41 and 42. The units are marked in intervals of 10° from 0° to 350° (360° being co-incident with 0°). By virtue of the inner and outer sets of graduations 24a, 24b, a user can accurately mark any angle along the first edge 14a and any angle along the second edge 28 directly from the graduations immediately adjacent the respective edge.

In addition to the graduations, the tool 10 includes marking indicative of a 90° line 30 within the protractor region 22. Further, the tool 10 includes markings 36 abutting against outer peripheral edges 14b, 14d, such that the tool 10 can function as a ruler.

As will be appreciated from FIG. 2, the origin or common centre O of the circles 41, 42 lies within the protractor aperture 26. Furthermore, in this embodiment the protractor aperture 26 is a major circle segment and includes a straight edge 32. Due to the radius of common writing implements, when the protractor aperture 26 is used as a template, the shape drawn by following the protractor aperture edges will be semi-circular. However, in alternative embodiments, the protractor aperture can be approximately semi-circular.

The 90° line 30 intersects the straight edge 32 at its midpoint. In use of the protractor region 22 to measure/mark angles, a user places a commonly used writing implement (such as a pen or pencil) on the vertex of the angle to be measured and the intersection of the straight edge 32 and the 90° line 30 against the writing implement. In this configuration, the centre O is co-incident with the vertex. The user can then measure/mark angle(s), as required.

In certain embodiments, the distance between the centre O and the intersection of the straight edge 32 and the 90° line 30 is approximately 0.5 millimetres. This distance corresponds with diameter of many commonly used writing implements.

The first edge 14a intersects tangentially with two of the other of the outer peripheral edges 14b, 14d of the planar body 12.

In this particular embodiment, the template apertures 18 consists of five circles, three ellipses, five triangles, two squares, one rectangle, two rhombuses, one pentagon, one hexagon, one octagon, and one elongate channel with the overall shape of a half dodecagon. Each template aperture defines a unique shape. Where template apertures have similar shapes, each is different in size (width, height, diameter) and/or proportions of edge lengths.

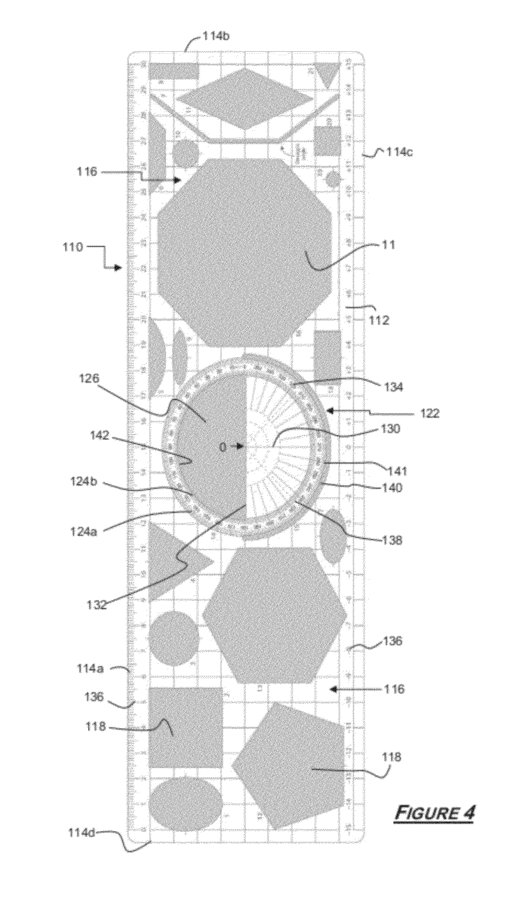

FIG. 4 shows a mathematics tool 110 in accordance with a second embodiment of the present invention. Features of the mathematics tool 110 that correspond with like features of the mathematics tool 10 have the same reference numerals with the prefix “1”.

The stencil region 116 of the mathematics tool 110 has different shapes of template apertures 118, number of apertures 118, and a different layout, when compared with that of the mathematics tool 10.

In addition, the protractor region 122 of the mathematics tool 110 is located centrally within the planar body 112, and spaced from the outer peripheral edges 114a, 114b, 114c, 114d. As with the tool 10, the tool 110 has a plurality of angularly spaced radial graduations 124a, 124b that extend around concentric circles 141 and 142. A first sector of the circle 141 has a first edge 138 of the tool that abuts against a radially outer end of the radial graduations. In this particular embodiment, the first edge is a tracing edge 138 of an arcuate aperture 140 within the protractor region 122. A second sector of the circle 142 has a protractor aperture 126 that includes a second edge 128 of the tool that abuts against a radially inner end of the radial graduations.

Thus, in this embodiment, the first and second edges 138, 128 are separate edges to the outer peripheral edges 114a, 114b, 114c, 114d of the tool 110.

In this particular embodiment, angles within the range of 0° to 180° can be marked along the second edge 128, and angles within the range of approximately 179° to 361° can be marked along the first edge 138.

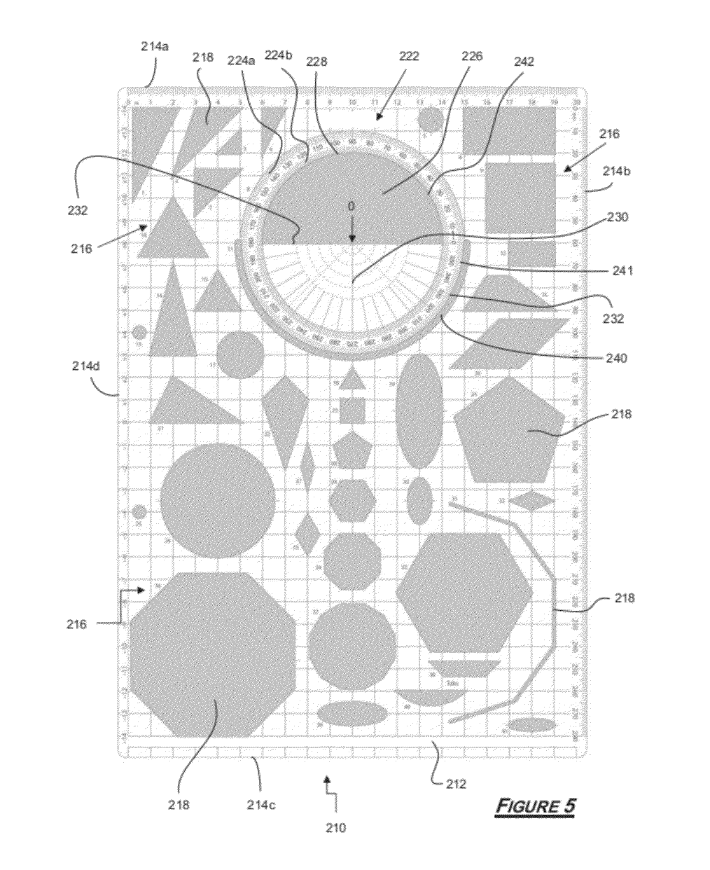

FIG. 5 shows a mathematics tool 210 in accordance with a third embodiment of the present invention. Features of the mathematics tool 210 that correspond with like features of the mathematics tool 10 have the same reference numerals with the prefix “2”.

The stencil region 216 of the mathematics tool 110 has different shapes of template apertures 218, number of apertures 218, and a different layout, when compared with that of the mathematics tool 10. Furthermore, the protractor region 222 of the mathematics tool 210 is located centrally within the planar body 212, and spaced from the outer peripheral edges 214a, 214b, 214c, 214d. As with the tool 10, the tool 210 has a plurality of angularly spaced radial graduations 224a, 224b that extend around concentric first and second circles 241 and 242. A first sector of the circle 241 has a first edge of the tool that abuts or interests against a radially outer end of the radial graduations. In this particular embodiment, the first edge is an edge 238 of an arcuate aperture 240 within the protractor region 222. A second sector of the circle 242 has a protractor aperture 226 that includes a second edge 228 of the tool that abuts or interests against a radially inner end of the radial graduations.

In this particular embodiment, angles within the range of 0° to 180° can be marked along the second edge 228, and angles within the range of approximately 179° to 361° can be marked along the first edge 238.

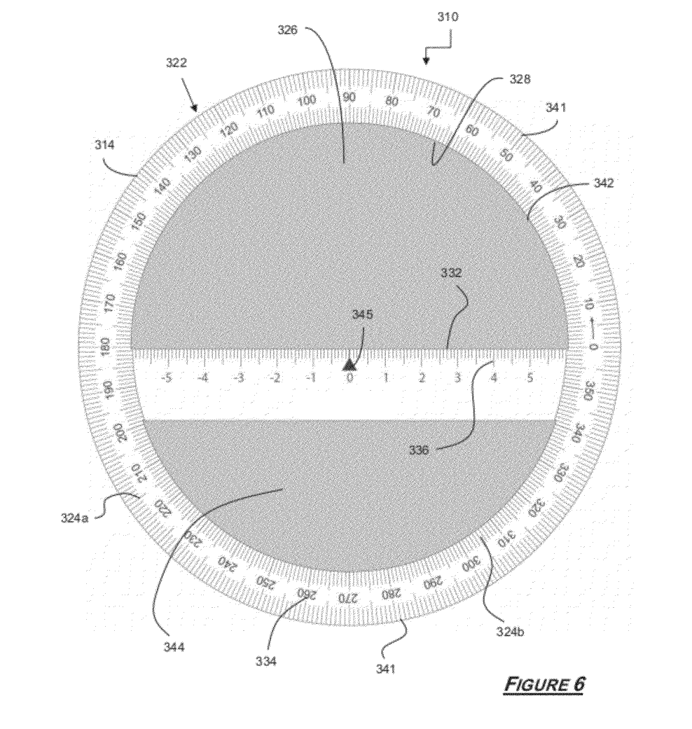

FIG. 6 shows a mathematics tool 310 in accordance with a fourth embodiment of the present invention. Features of the mathematics tool 310 that correspond with like features of the mathematics tool 10 have the same reference numerals with the prefix “3”.

The mathematics tool 310 differs from the embodiments illustrated in FIGS. 1 to 5 in that it does not have a stencil region. In contrast, the tool 310 only has a protractor region 322. Thus, the outer peripheral edge, which is also the first edge 314, defines concentric first and second circles 341 and 342.

In this particular embodiment, angles within the range of 0° to 360° can be marked along the first edge 314, and angles within the range of approximately −0.75° to 180.75° can be marked along the second edge 328. Thus, the sum of angles subtended by the first and second sectors is approximately 541.5°.

The tool 310 has an arrowhead 345 that indicates the location of the midpoint of the straight edge 332. The arrowhead 345 is used to locate the origin of the circle with respect to the vertex of an angle to be measured/marked. The straight edge 332 abuts against markings 336 to form a ruler.

The tool 310 further has a second aperture 344, which has the shape of a minor circle segment.

It will be understood to persons skilled in the art of the invention that many modifications may be made without departing from the spirit and scope of the invention.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A mathematics tool comprising a body, and the body comprises:
a 360 degree protractor having angularly spaced graduations; and
a plurality of tracing edges that each continuously extend over arcs of at least 90 degrees, the tracing edges being marked with angular graduations, and the tracing edges having different radii about a common centre and are arranged circumferentially about the centre so that collectively, the tracing edges encircle a complete 360 degrees of the protractor.

2. The mathematics tool according to claim 1, wherein the mathematics tool comprises only two of the tracing edges.

3. The mathematics tool according to claim 2, wherein the two tracing edges each have arcs of at least 180 degrees that overlap at two regions.

4. A mathematics tool comprising a body, and the body comprises:
a 360 degree protractor having a tracing edge extending around the protractor and angularly spaced graduations, the tracing edge including a first tracing edge, and a second tracing edge;
the first tracing edge extends continuously over a first arc covering at least 90 degrees and is marked with the angular graduations; and
the second tracing edge extends continuously over a second arc covering at least 90 degrees and is marked with the angular graduations;
wherein the first and second tracing edges have different radii about a common centre.

5. The mathematics tool according to claim 4, wherein at least one of the first and second tracing edges extend over at least 180 degrees.

6. The mathematics tool according to claim 4, wherein both of the first and second tracing edges extend over at least 180 degrees.

7. The mathematics tool according to claim 4, wherein the first and second tracing edges at least partially overlap circumferentially.

8. The mathematics tool according to claim 7, wherein portions of the first tracing edge that overlaps circumferentially with a portion of the second tracing edge defines a sector of the circle that is within the range of 0.5° to 5°.

9. The mathematics tool according to claim 7, wherein there are two portions of the first tracing edge that each overlap circumferentially with the second tracing edge.

10. The mathematics tool according to claim 4, wherein the first tracing edge is located on an outer peripheral edge of the body of the mathematics tool and intersects tangentially with another outer peripheral edge of the planar body.

11. The mathematics tool according to claim 4, wherein the first tracing edge is provided by a cut out, such as an arcuate aperture or slot, located inwardly of an outer peripheral edge of the body of the mathematics tool.

12. The mathematics tool according to claim 4, wherein the first tracing edge has a larger radius than the radius of the second tracing edge.

13. The mathematics tool according to claim 4, wherein the second tracing edge is provided by a protractor aperture, such as a cut out, arcuate aperture or arced slot, located inwardly of an outer peripheral edge of the body of the mathematics tool.

14. The mathematics tool according to claim 13, wherein the protractor aperture is approximately semi-circular or a major circle segment.

15. The mathematics tool according to claim 13, wherein the common centre of the first and second tracing edges lie within the protractor aperture.

16. The mathematics tool according to claim 4, wherein the angularly spaced graduations are radially directed graduations and include an inner set of graduations and an outer set of graduations, and the inner set of the graduations intersect with the second tracing edge and the outer set of graduations intersect with the first tracing edge.

17. The mathematics tool according to claim 4, wherein the body of the mathematic tool also includes one or more geometric stencils within which are located a plurality of template apertures.

18. The mathematics tool according to claim 4, wherein body of the mathematics tool is circular.

19. The mathematics tool according to claim 4, wherein the 360 degree protractor comprises only two tracing edges, namely said first and second tracing edges.

20. A protractor comprising:
a circular body having angularly spaced graduations and a tracing edge that extends 360 degrees around the body, the tracing edge having a first tracing edge, and a second tracing edge;
the first tracing edge extends continuously over a first arc covering at least 90 degrees and is marked with the angular graduations; and
a second tracing edge extends continuously over a second arc covering at least 90 degrees and is marked with the angular graduations;
wherein the first and second tracing edges have different radii.

21. The protractor according to claim 20, wherein the first tracing edge is provided by an outer peripheral edge of the circular body, and the first tracing edge completely overlaps the second tracing edge which has a smaller radius than the radius than the first tracing surface.

22. The protractor according to claim 21, wherein the second tracing edge is provided by a protractor aperture located inwardly of an outer peripheral edge of the body of the mathematics tool.

23. The protractor according to claim 22, wherein the protractor aperture is approximately semi-circular, a major circle segment, an arcuate aperture, or an arced slot.

24. The protractor according to claim 22, wherein the common centre of the first and second tracing edges lie within the protractor aperture.

25. The protractor according to claim 21, wherein the angularly spaced graduations are radially directed graduations and include an inner set of graduations and an outer set of graduations, and the inner set of the graduations intersect with the second tracing edge and the outer set of graduations intersect with the first tracing edge.
